(19) United States
(12) Patent Application Publication
(10) Pub. No.: US 2010/0005835 A1
(43) Pub. Date: Jan. 14, 2010

(54) Pearl containing cremated remains

(76) Inventors: Raymond Keith Johnson, SR., Barre, VT (US); Thomas George Ference, Essex Junction, VT (US)

Correspondence Address: Thomas G. Ference, 38 Thasha Lane #C6, Essex Junction, VT, 05452, US

(21) Appl. No.: 12/459,927

(22) Filed: Jul. 9, 2009

Related U.S. Application Data
(60) Provisional application No. 61/134,483, filed on Jul. 10, 2008.

(51) Int. Cl. A44C 17/00; A61G 17/00; A01K 61/00

(52) U.S. Cl. 63/36; 27/1; 119/244

(57) ABSTRACT

A pearl comprised of cremated remains surrounded by nacre. The cremated remains may be from any person or pet. The pearls containing cremated remains can be incorporated into fine jewelry to create ageless, beautiful keepsakes for the remembrance of deceased loved ones.

### RELATED APPLICATIONS

This application claims the benefit of priority of U.S. Provisional Patent Application No. 61/134,483, filed Jul. 10, 2008 entitled “Pearl Containing Cremated Remains”, which is incorporated herein by reference.

### FIELD OF THE INVENTION

This invention relates generally to structures for preserving and memorializing the remains of humans and animals. In particular, the present invention is directed to a structure and method of entombing cremated remains in a pearl.

### BACKGROUND OF THE INVENTION

The popularity of cremation is growing within modern society as an alternative to preserving bodies and burying them in coffins. Cremation is also becoming a popular method of dealing with pet remains. Cremation is usually less expensive and more ecological than burial. It also offers living individuals an opportunity to keep some of the deceased's ashes close to them to help facilitate a spiritual connection with the deceased. Although prior art structures such as urns and lockets exist for holding cremated ashes, these do not integrate the ashes with nature's natural beauty in a way that produces a natural gem, a gem which can then be used for remembrance of the deceased and integrated into jewelry to connect the ash remains with the living.

### SUMMARY OF THE INVENTION

One aspect of the present invention is directed to a pearl comprising cremated remains surrounded by nacre.

Another aspect is directed to a method of forming a pearl containing cremated remains comprising the steps of providing cremated remains and surrounding the cremated remains with nacre.

Still another aspect is directed to a method of forming a pearl containing cremated remains comprising the steps of providing a nucleus containing cremated remains, inserting the nucleus into a nacre producing mollusk, allowing the mollusk to deposit nacre around the nucleus and then harvesting the pearl from the mollusk.

Yet another aspect is directed to a method of forming a pearl containing cremated remains comprising the steps of providing a nucleus containing a hollow region and inserting the nucleus into a nacre producing mollusk, allowing the mollusk to deposit nacre around the nucleus and harvesting the pearl from the mollusk. An opening is created in the nacre to access the hollow region and cremated remains are inserted through the hole into the hollow region.

Still yet another aspect is directed to a method of fabricating a pearl containing cremated remains comprising the steps of providing a pearl having an outer surface coated with nacre, creating an opening in the nacre to form a hollow region interior the nacre and inserting cremated remains into the hollow region.

### BRIEF DESCRIPTION OF DRAWINGS

The foregoing and other aspects and advantages of the invention will be apparent from the following detailed description of the invention, as illustrated in the accompanying drawings, in which:

FIG. 1a is a sectional view of a pearl in accordance with the present invention showing cremated remains surrounded by nacre;

FIG. 1b is a sectional view of a pearl in accordance with the present invention further incorporating a transitional layer and a protective layer;

FIG. 2a is a schematic of components that may be used in a method of forming a pearl containing cremated remains;

FIG. 2b is a schematic of a composite material made from the components shown in FIG. 2a;

FIG. 2c is a schematic showing pre-nucleus elements cut from the composite material shown in FIG. 2b;

FIG. 2d is a schematic showing nuclei formed from the pre-nucleus elements of FIG. 2c;

FIG. 2e is a schematic of a mollusk seeded with a nucleus from FIG. 2d;

FIG. 2f is a schematic of the mollusk of FIG. 2e after time has passed and the mollusk has deposited nacre to surround the nucleus;

FIG. 2g is a sectional view of a harvested pearl after being formed during the method depicted in FIGS. 2a-f;

FIG. 3a is sectional view of two halves of a transitional layer used to form a nucleus containing cremated remains;

FIG. 3b is a sectional view of the two halves of a transitional layer of FIG. 3a now filled with cremated remains;

FIG. 3c is a sectional view of a nucleus formed by bonding together the two halves of the structures shown in FIG. 3b;

FIG. 3d is a sectional view of a pearl containing cremated remains after nacre is deposited around the nucleus of FIG. 3c by a mollusk;

FIG. 4a is a sectional view of a transitional layer used to create a hollow region which is then used to form a nucleus containing cremated remains;

FIG. 4b is a sectional view of the structure in FIG. 4a, now filled with cremated remains;

FIG. 4c is a sectional view of a pearl containing cremated remains after nacre is deposited around the nucleus of FIG. 4b by a mollusk;

FIG. 5a is a sectional view showing a hollow nucleus;

FIG. 5b is a schematic of a mollusk seeded with a hollow nucleus from FIG. 5a;

FIG. 5c is a schematic of the mollusk of FIG. 5b after time has passed and the mollusk has deposited nacre to surround the hollow nucleus;

FIG. 5d is a sectional view of the pearl formed during the method depicted in FIGS. 5a-c, now with an opening in the nacre and transitional layer allowing access to the hollow region;

FIG. 5e is a sectional view the pearl of FIG. 5d, now filled with cremated remains;

FIG. 6a is a sectional view providing a natural pearl or a cultured pearl in accordance with another embodiment of the present invention;

FIG. 6b is a sectional view illustrating the step of creating an opening into the nacre on the outer surface of the pearl provided in FIG. 6a and then creating a hollow region within the pearl;

FIG. 6c is a sectional view illustrating the step of filling the hollow region of FIG. 6b with cremated remains;

FIG. 6d is a sectional view illustrating the step of further drilling a hole through the pearl of FIG. 6c to allow it to have a link run through it to create a pearl necklace;

FIG. 7a is a perspective view illustrating a pearl necklace formed from pearls containing cremated remains in accordance with the present invention;

FIG. 7b is a perspective view illustrating a pearl earring formed from pearls containing cremated remains in accordance with the present invention; and

FIG. 7c is a perspective view illustrating a pearl ring formed from pearls containing cremated remains in accordance with the present invention.

### DETAILED DESCRIPTION OF THE INVENTION

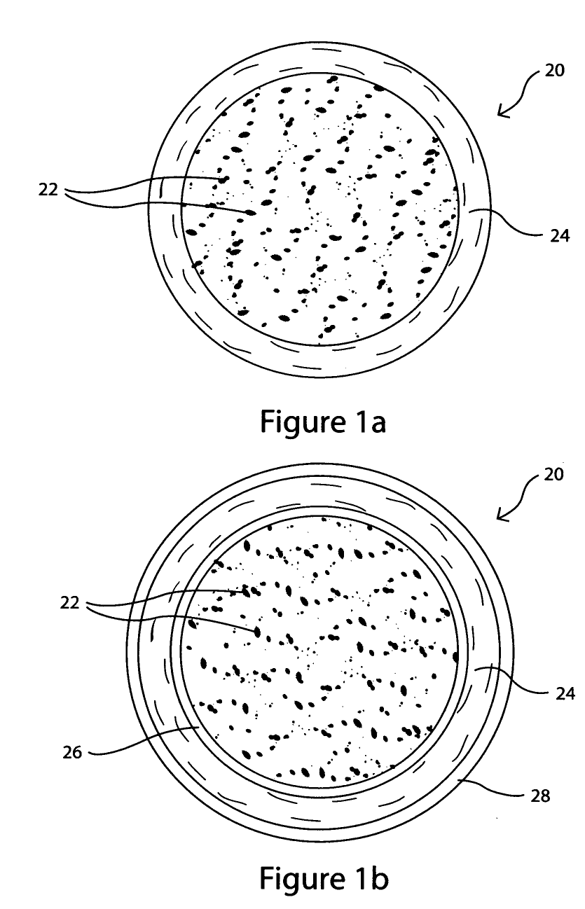

FIGS. 1-7 illustrate the structure and process of entombing cremated remains within a pearl. Such pearls containing cremated remains can be incorporated into fine jewelry to create ageless, beautiful keepsakes for the remembrance of decided loved ones. In a first embodiment of the invention, FIGS. 1a and 1b, pearl 20 comprises cremated remains 22 (a.k.a cremation ashes, ash remains, ashes or remains) surrounded by nacre 24 deposited by mollusk 25. Cremated remains 22 may be from any person or pet. Nacre 24 is a naturally occurring organic/inorganic composite that is a combination of crystalline and organic substances that form the iridescent inner lining of the shell of certain mollusks. Depending on the exact method of entombing cremated remains 22, a transitional layer 26 may exist between ashes 22 and nacre 24. Transitional layer 26 is used to transition from cremated remains 22 to nacre 24. Transitional layer 26 may be a simple barrier layer between nacre 24 and remains 22, a layer of nacre 24 previously deposited during a separate process, a layer having specific properties (i.e., a material having thermal expansion and density matched to nacre) or it may just be a layer for holding remains 22. Pearl 20 may further include a protective coating 28 on the external surface of nacre 24.

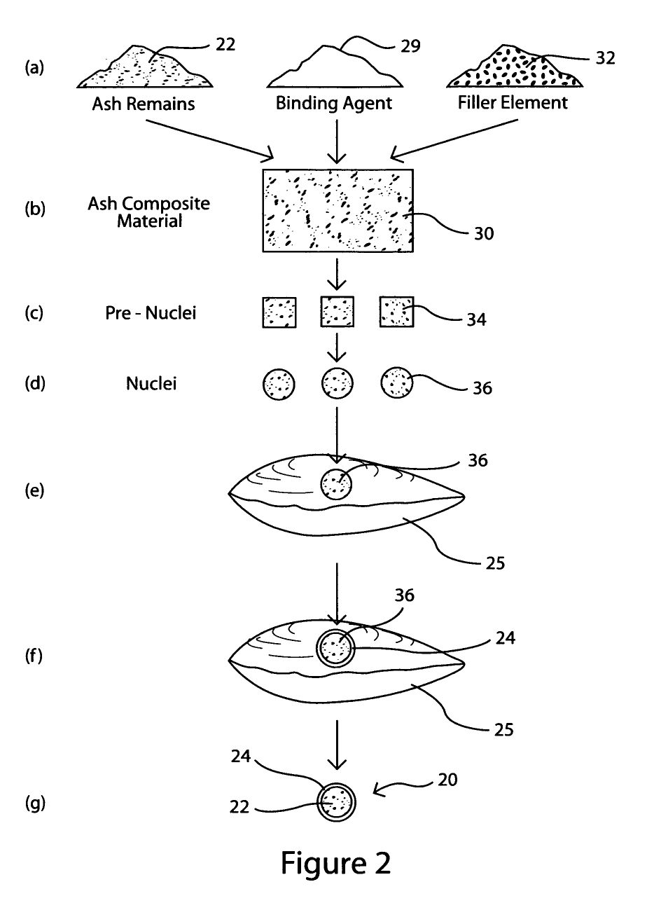

FIGS. 2a-g illustrates a first method of entombing cremated remains 22 in a pearl 20 to provide the structures depicted in FIGS. 1a and 1b. The process comprises taking cremated remains 22 and mixing them with a binding agent 29 to create a composite material 30. Binding agent 29 may be an epoxy, glass or any other material that when mixed with or without the presence of heat can bind ashes 22 into a solid material. Ashes alone may be compressed under heat and pressure to form a solid composite material 30 from which to form nuclei 36, however, the addition of a binding agent may be used to facilitate creating a solid material. Composite material 30 may further incorporate filler material 32 to help match the material properties of the composite material to be close in density to that of the host mollusk 25 and with a similar coefficient of expansion to nacre 24 deposited by the mollusk. Having nucleus 36 with density and coefficient of expansion matched to that of nacre 24 to be deposited provides for a smooth pearl that will not build up stresses and crack with temperature changes during and after the deposition of the nacre. Examples of filler materials 32 include, but are not limited to mollusk shell, byronite and calcium carbonate. The resulting composite material is cut into pre-nuclei 34, rounded and polished to create a substantially spherical nucleus 36. Nucleus 36, however, may take on other shapes to meet the final desired shape of pearl 20. A transitional layer 26 may also be coated onto each nuclei at this step in the process. A salt water mollusk 25 is nucleated by making a small incision to the gonad—the animal's reproductive organ. The nucleus 36 is inserted into this incision, which is then followed with a small piece of mantle tissue from a donor mollusk. The mantle tissue is placed between nucleus 36 and the gonad with the side containing epithelial cells facing the nucleus. These epithelial cells are the catalyst of the pearl sac. Mollusk 25 engages nucleus 36 as a foreign object that the mollusk cannot eject and tries to entomb the foreign object (nucleus containing cremated remains) with successive, concentric layers of nacre 24. In a defensive response to nucleus 36, mollusk 25 secretes nacre as a smooth, protective coating. Mollusk 25 does this by growing a pearl sac around the nucleus and deposits nacre 24 by a process known as encystation. This nacre 24 and its layering create the beauty of the pearl. After a period of time, usually one to two years, pearl 20 is harvested from mollusk 25. Pearl 20 containing cremated remains 22 may then be used and process by standard methods of handling cultured pearls to create jewelry.

An important part of entombing cremated remains, is keeping track of which cremated remains 22 are in which pearl 20. This can be accomplished through several techniques using an identifying mechanism. For example most cultured pearls are created by keeping mollusks 25 in cages while in the water. It would be easy to have the cage marked with an identifying number associated with a given individual's or pet's cremated remains 22. All pearls taken from those mollusks in the same cage would then be kept in the same container after harvesting and tracked through further processing. Alternatively, a small RFID (radio frequency identification) tag or similar identifying device could be embedded in each nucleus 36 along with cremated remains 22. The RFID chips could be activated by radio frequency radiation at any time and an RFID reader used to verify the identity of remains 22. Other identification methods, such as mechanical markings on the nucleus, chemical markers embedded in the nucleus that can be detected externally by analytical techniques, etc. could be used to track and verify a specific individual's remains with a specific pearl.

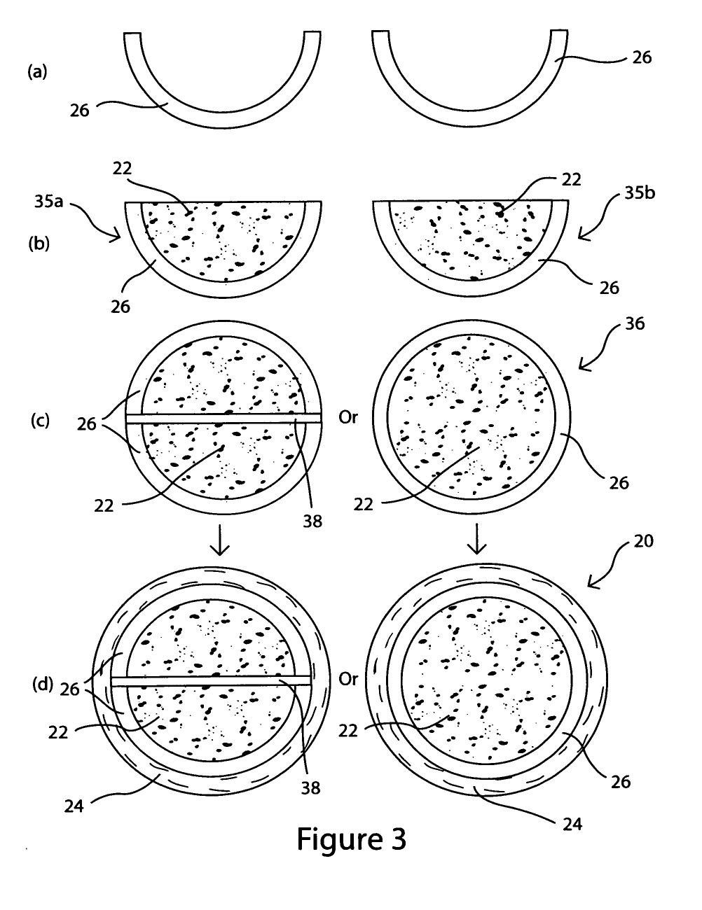

FIGS. 3a-d illustrate a second method of creating nucleus 36 containing cremated remains 22. In this embodiment, transition layer 26 is preformed as hemispheres for holding cremated remains 22, FIG. 3a. Transition layer 26 may be formed from mollusk shell, byronite, calcium carbonate, a suitable glass or any other suitable material. Remains 22 are mixed with binding agent 29. A filler material 32 may also be added. The hemispheres are then filled with composite material 30 containing the remains, FIG. 3b. The two hemispheres 35a and 35b are then bonded together with an adhesive 38, FIG. 3c. Alternatively, the hemispheres 35a and 35b may be directly bonded to each other by allowing binding agent 29 to bond the two hemispheres, or by suing thermal or sonic bonding. Nucleus 36 may be further smoothed or polished at this point to provide a smoother nucleus. The resulting nucleus 36 is then placed in mollusk 25 in a similar manner to the method depicted in FIGS. 2e and 2f. After mollusk 25 has deposited nacre 24 to surround nucleus 36, pearl 20 containing cremated remains 22 is harvested, FIG. 3d.

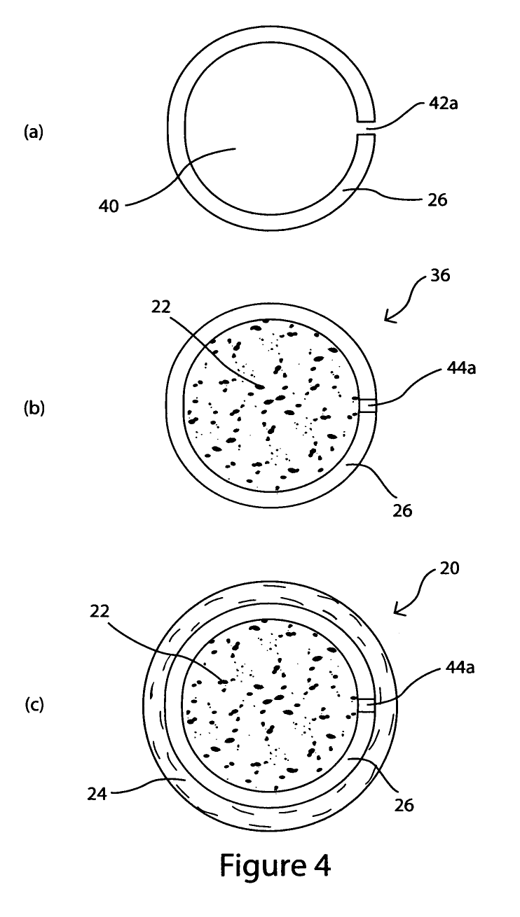

FIGS. 4a-d illustrate a third method of creating nucleus 36 containing cremated remains 22. In this embodiment, transition layer 26 is preformed as a sphere having a hollow region 40 for holding cremated remains 22, FIG. 4a. Transition layer 26 may be formed from mollusk shell, byronite, calcium carbonate or a suitable glass. Remains 22 are mixed with binding agent 29 and the sphere filled through opening 42a with the composite material 30 containing the remains, FIG. 4b. A plug 44a may be used to seal opening 42a. Nucleus 36 may be further smoothed or polished at this point to provide a smoother nucleus. The resulting nucleus 36 is then placed in mollusk 25 in a similar manner to the method depicted in FIGS. 2e and 2f. After mollusk 25 has deposited nacre 24 to surround nucleus 36, pearl 20 containing cremated remains 22 is harvested, FIG. 4c.

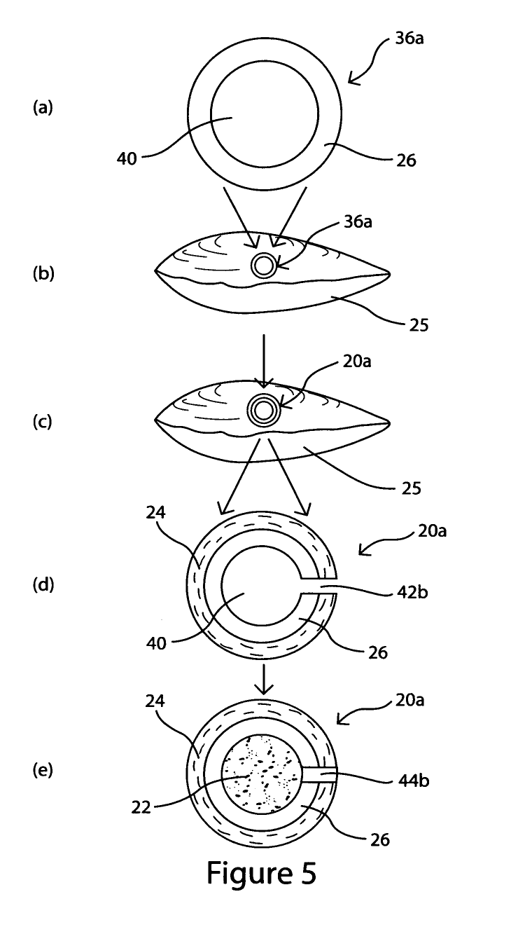

FIGS. 5a-d illustrate a fourth method of creating a nucleus 36 and an associated method of entombing cremated remains 22 within pearl 20. In this embodiment, transitional layer 26 is pre-formed as a sphere having a hollow region 40 for holding cremated remains 22, FIG. 5a. However, in this embodiment, the hollow region 40 is sealed from the environment with no holes. Hollow nuclei 36a could be formed from a solidified glass bubble or two hollow hemispheres that have been sintered together. Hollow nuclei 36a is then placed within mollusk 25 in a similar manner to the method described in FIGS. 2e and 2f. After mollusk 25 has deposited nacre 24 to surround hollow nucleus 36a, pearl 20a having hollow region 40 is harvested, FIG. 5d, and an opening 42b created to access the hollow region Cremated remains 22 are then inserted into pearl 20a and opening 42b sealed with plug 44b to form pearl 20 containing the cremated remains. Using this method, one does not have to wait years to get a pearl containing cremated remains.

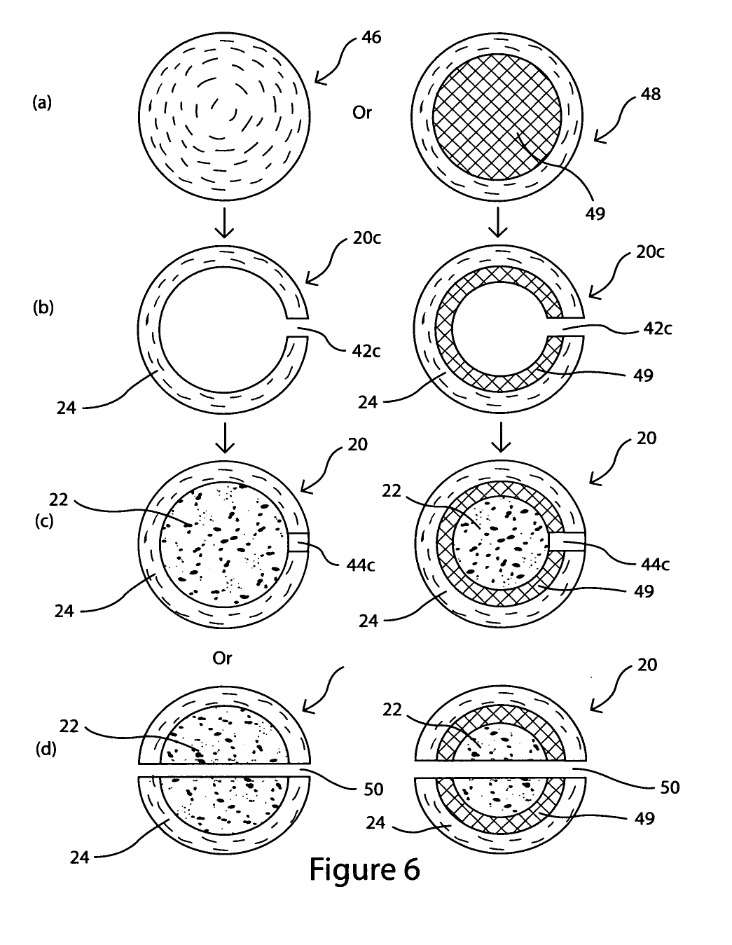

FIGS. 6a-d illustrate another embodiment of a method of creating pearl 20 containing cremated remains 22. In this method a natural pearl 46 or a cultured pearl 48 grown on non-cremated nucleus 49 is provided, FIG. 6a. Natural pearl 46 or cultured pearl 48 then have an opening 42c created in them and hollow region 40 formed, FIG. 6b, creating a hollow pearl 20c. Hollow region 40 of hollow pearl 20c is then filled with cremated remains 22 through opening 42c to create pearl 20 containing cremated remains 22, FIG. 6c. Cremated remain 22 filling hollow region 40 may be just the remains or a composite material 30 including the remains. A plug 44c may be used to seal hole 42c. A through-hole 50, FIG. 6d, may be further provided for stringing pearl 20 to create a string of pearls.

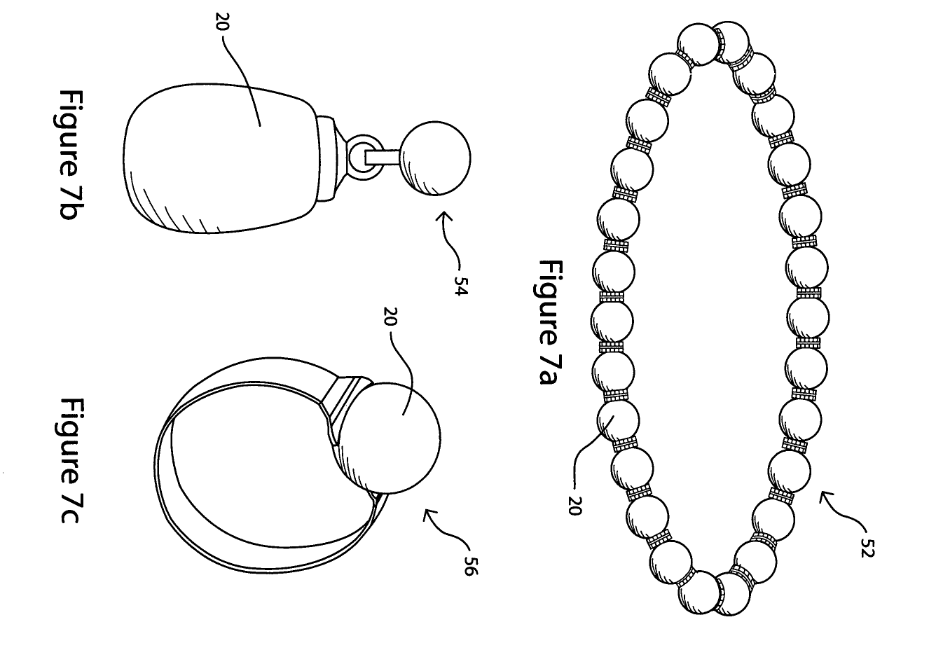

Pearls 20, created by any of the means defined above, may be drilled or mounted to create pieces of jewelry as shown in FIGS. 7a-c. For example one may create a string of pearls 52 from a plurality of pearls 20 containing cremated remains. Each pearl may contain remains 22 from a different family member or pet. String of pearls 52 provide a beautiful and intimate way for the living to link with the dead. Other examples of jewelry that may be made with pearls 20 are a pearl earring 54 or a pearl ring 56.

The invention is not limited to the embodiments represented and described above but includes all variants notably those concerning the types of transition materials used, the types of binding agents used, the types of filler materials used and the shape of the nucleus or pearl created. Nothing in the above specification is intended to limit the invention more narrowly than the appended claims. The examples given are intended only to be illustrative rather than exclusive.

What is claimed is:

1) A pearl comprising cremated remains surrounded by nacre.

2) A pearl as recited in claim 1, wherein said cremated remains are a nucleus for growing said pearl.

3) A pearl as recited in claim 2, wherein said nucleus is substantially spherical.

4) A pearl as recited in claim 2, wherein said nucleus further includes at least one from the group including a binding agent and a filler material.

5) A pearl as recited in claim 2, wherein said nacre is deposited on said nucleus while said nucleus is within a nacre producing mollusk.

6) A pearl as recited in claim 2, wherein the nucleus has a density and thermal coefficient of expansion substantially matched to that of said nacre.

7) A pearl as recited in claim 1, further comprising a transitional layer between said cremated remains and said nacre.

8) A pearl as recited in claim 1, further comprising a protective coating on the external surface of said nacre.

9) A pearl as recited in claim 1, wherein said cremated remains are contained within a hollow region formed within said nacre.

10) A method of forming a pearl containing cremated remains, comprising the steps of:
a) providing cremated remains; and
b) surrounding said cremated remains with nacre.

11) A method as recited in claim 10, further comprising providing an identifying mechanism to identify said pearl to a specific deceased being.

12) A method of forming a pearl containing cremated remains, comprising the steps of
a) providing a nucleus containing cremated remains;
b) inserting said nucleus into a nacre producing mollusk;
c) allowing the mollusk to deposit nacre around said nucleus, and
d) harvesting said pearl from said mollusk.

13) A method as recited in claim 12, wherein said inserting step includes inserting a piece of mantle tissue with epithelial cells facing towards said nucleus.

14) A method of forming a pearl containing cremated remains, comprising the steps of:
a) providing a nucleus containing a hollow region;
b) inserting said nucleus into a nacre producing mollusk;
c) allowing the mollusk to deposit nacre around said nucleus;
d) harvesting said pearl from the mollusk; and
e) creating an opening in said nacre to access said hollow region and inserting cremated remains through said hole into said hollow region.

15) A method of forming a pearl containing cremated remains, comprising the steps of
a) providing a pearl having an outer surface surrounded with nacre;
b) creating an opening in said nacre to form a hollow region interior said nacre; and
c) inserting cremated remains into said hollow region.

16) A method as recited in claim 15, wherein said providing step includes providing at least one from the group of a natural pearl and a cultured pearl.

17) A method as recited in claim 15, wherein during said creating step said hollow region is formed by at least one from the group including drilling, cutting and etching.
